(19) United States
(12) Patent Application Publication
(10) Pub. No.: US 2008/0294500 A1
(43) Pub. Date: Nov. 27, 2008

(54) SYSTEM AND METHOD FOR INCREASING DEMAND FOR PERISHABLE GOODS OR VANISHING GOODS AT A POINT-OF-SALE LOCATION

(75) Inventors: Bernard G. Koether, Fort Lauderdale, FL (US); Ronald E. Small, JR., Kennesaw, GA (US)

Correspondence Address: EDWARDS ANGELL PALMER & DODGE LLP, P.O. BOX 55874, BOSTON, MA, 02205, US

(73) Assignee: Technology Licensing Corporation, Fort Lauderdale, FL (US)

(21) Appl. No.: 12/100,867

(22) Filed: Apr. 10, 2008

Related U.S. Application Data
(60) Provisional application No. 60/939,938, filed on May 24, 2007.

(51) Int. Cl. G06Q 10/00

(52) U.S. Cl. 705/10

(57) ABSTRACT

A method for improving communications to customers therefore increasing demand for a perishable or vanishing item produced, inventoried and/or sold at a facility is provided. The method monitors the sales and production and availability of the perishable or vanishing item at a facility for sale of the perishable or vanishing item and determines if more demand is needed for the perishable or vanishing item and the time period necessary for existing customers to meet the determined demand, and notifies the sales staff and potential customers within the facility when a time period in which the perishable or vanishing item waste is less than that of the determined time period.

### CROSS-REFERENCE TO RELATED APPLICATION

This application claims priority under 35 U.S.C. 119(e) to U.S. Provisional Patent Application No. 60/939,938, filed May 24, 2007.

### BACKGROUND OF THE INVENTION

This application is directed to driving demand for perishable or vanishing goods at the point-of-sale, such as at restaurants, supermarkets, bakeries, meat wholesalers, butchers, wine manufacturers, fruit wholesalers, product markets retail and wholesale, or transportation or entertainment facilities offering participation space as well as non food items that have a “valuable life cycle” that is predictable, and related to inventory availability and monitored by a data base system, and more particularly, for targeting purchasers of the perishable goods as a function of customer geographic location in real time.

It is known in the art to predict product demand for goods at retail, wholesale, or transportation or entertainment facilities offering participation space, or processor facilities based on experience. With the advent of computer technology, modeling has been developed to predict demand for goods. However, at locations where goods are perishable, such as restaurants, bakeries, supermarkets, food processing facilities, the model can be upset by anything from an unforeseen competing event, weather, traffic jams, the absence of regular customers for any unexpected reasons, or errors made in the production process; any combination of which could leave the entity with excess perishable inventory. If the goods are not sold within their perishable life, they must be discarded and no revenue is recognized by the owner.

Furthermore, these facilities and restaurants are staffed with personnel and provided with equipment that meets optimum predicted sales at peak traffic times. Accordingly, at traditional rush hours such as lunchtime and dinnertime the facility or restaurant is able to operate at or near full capacity. However, there are down times between the peak hours of sale during which the inventory of equipment, personnel and foodstuffs or other inventory of vanishing assets is under utilized. Although the predictive models may be able to predict these down times, it is still inefficient to idle equipment or send staff home for an interim time period. Conversely, if demand unpredictably slows, then food in process will go to waste.

Furthermore, the current method for driving demand within the retail facility or store is for the preparation or operations staff to communicate to the sales staff that a certain food or vanishing item is about to become waste or vanish. This is done on an ad hoc basis, usually by the operations or preparation staff leaving their station to talk to the sales staff at the counters, or communicating in some other fashion,

Accordingly, a methodology and system that overcome the shortcomings of the prior art are desired.

### BRIEF SUMMARY OF THE INVENTION

In accordance with the invention, a method for increasing demand for a perishable or vanishing item utilizing production or inventory capacity planning in a bakery, restaurant, supermarket, or food processing, transportation or entertainment facility, which allows for flexibility and production forecastability to determine a necessary number of customers within a time interval to balance demand with production or inventory capacity is provided. The determination is made as a function of raw material, labor availability, work in process, and food in holding cabinets or other inventory in storage, awaiting purchase. By monitoring this production and inventory capacity and the trend of sales, by utilizing probability theory, and expected sales in a given time interval necessary demand to optimize sales is predicted. It is then determined how many additional sales must be made within a predetermined period in order to prevent waste, given the predicted in store traffic of customers. At the beginning of the determined time interval, a message is sent by electronic intra-facility communication to the staff responsible for selling product within the facility. It is envisioned that within facilities where competing brands offering similar products and services are operating, an inter company exchange of this inventory and ability to offer services could be offered to participating members so that excess demand could be offered to units with excess capacity and vice versa.

In a preferred embodiment, the communication is by display at a point-of-sale device. In other embodiments, the communication may be by radio frequency, cellular phone, pager or any other type of electronic communication to sales staff either in the facility or at remote order centers via an Internet connection, (a virtual sales person on site). Another embodiment is to broadcast these messages on display boards as advertising either at kiosk order points or in waiting rooms and lobbies

### BRIEF DESCRIPTION OF THE DRAWINGS

FIG. 1 is a schematic drawing of a communication system in accordance with the invention; and

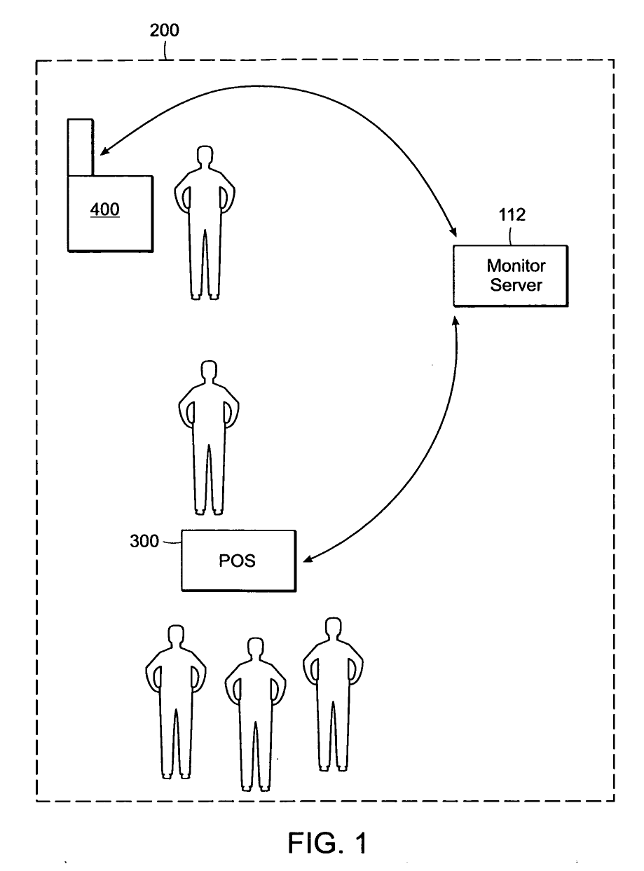

FIG. 2 is a flowchart for the method of driving demand in accordance with the invention.

### DETAILED DESCRIPTION OF THE INVENTION

A perishable asset facility 200 includes at least one food preparation process embodied for ease of description as a single device 400 such as a cooker, chiller, cutter, baking oven, fryer, or a process system that ferments or ages a product to a time based sensitive prime condition for best sale date, and at least one point-of-sale device 300 such as a cash register, a credit card terminal, a kiosk, drive through menu, bio-recognition device, or any other device capable of billing a personal or business account for payment of goods Food production monitoring devices such as the Kitchen Advisor™ manufactured by Food Automation—Service Techniques, Inc. are known in the art to monitor food preparation equipment. As server 112 can monitor fryer 400. By monitoring fryer 400, server 112 may determine how much food is being made and keep a running inventory of available food.

As is known from SCK Direct Inc.'s Smart Commercial Kitchen® Solutions it is known to monitor point-of-sale device 300. Server 112 determines how much product has been sold, i.e., consumed as a function of monitored sales. By comparing the perishable asset production (created assets) to the perishable assets sold (consumption), server 112, may determine a current perishable asset supply (inventory) and projected perishable asset or food supply as a function of demand. Server 112 may also determine when the perishable item is no longer saleable, which results in waste of the asset. Furthermore, by monitoring one or more perishable asset production devices, such as ovens and fryers 400 at perishable asset production facility such as a bakery or restaurant 200, server 112 may determine what percentage of capacity is currently being used.

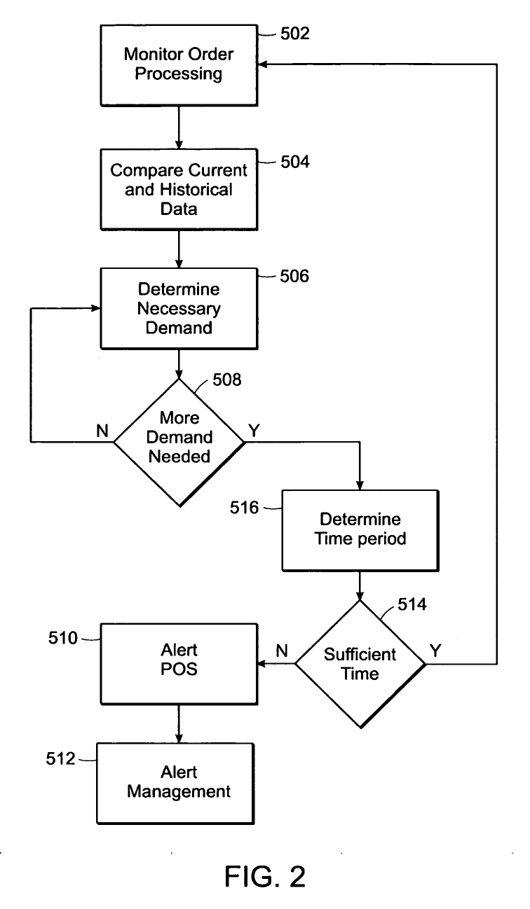

Generally, server 112 utilizes information to determine an anticipated theoretical production quantity, if all available production assets (labor, production devices, raw materials) were utilized. Server 112 also determines usage for the labor, production devices and raw material to determine whether to increase production from an under utilized state to meet a projected demand based on sales or a created demand based on efforts to drive additional customers to facility 200. Server 112 also determines necessary demand, given production levels and consumption levels to prevent potential waste if the food determined to be available (inventory) is in fact not sold. Reference is now made to FIG. 2, which shows an algorithm for encouraging customers within the facility, such as a bakery, supermarket or restaurant 200 to purchase in an amount necessary to match demand to food currently in preparation.

As discussed above, in a first step 502, server 112 monitors the order processing system of the perishable asset generating facility, such as a bakery supermarket or restaurant 200 including the point-of-sale device 300 and food production devices exemplified by fryer 400. Server 112 includes an associated database which may store historic data such as previous production rates, perishable items on hand, raw materials on hand, or past sales history (indicative of demand) for facility 200, or a model of a generic facility. Current production as determined from monitoring fryer 400 and available capacity is determined. In a step 504, the current production data, work-in-process, available raw materials, inventory (unsold but available items) and production capacity is compared to historical sales at the same facility 200, or a representative model of a facility in a step 504.

In a step 506, server 112 applies predictive algorithms to dynamically determine the necessary demand to meet the production forecast. The production forecast is a function of raw material, labor availability, work in process (perishable assets or food currently being cooked, prepared, conditioned or aged) and the inventory of such perishable assets held in finished or semi finished state in storage refrigerators, or heated holding cabinets or displays. Utilizing current trend sales and probability theory, server 112 calculates the expected sales in a given time interval and then determines whether or not more demand is needed to prevent waste of inventory (as the goods are perishable). If no more demand is needed, then the process is repeated in step 502.

In a preferred embodiment, the capacity planning algorithm calculates the individual capacity of each appliance 400 based upon its physical capacity, labor available to load and operate the appliance, the condition of the appliance (whether or not maintenance is required such as a shortening change, a burner cleaning or the like) the available raw materials and their prep time or any such set of factors related to the production of the perishable asset. As an added feature, server 112 could provide directions to the staff providing what perishable asset such as a food item to cook, when and where.

If it is determined in step 508 that more demand is needed then server 112 utilizes a predictive model as discussed above to determine a time period necessary for current customers to consume an amount of food to prevent wastage. If there is sufficient time for current consumption to avoid wastage, then no more demand would be needed and the processing occurs as discussed above beginning at step 502. However, if it is determined that based upon current customer demand there is insufficient time to prevent waste, than at that moment it is determined that demand must be increased.

The sales staff and/or customer audience is notified in a step 510. The notification takes the form of an alert to the sales staff or an offering posted to potential customers on public display boards and kiosks that a certain item should be offered to every customer as a recommendation. If demand is not increased sufficiently to prevent waste within the remaining time period, then a notification that a discount may be offered will be sent to the sales staff or display board in step 510. The notification is sent by way of an alert on the display of a point-of-sale device 300, by communication to an earpiece of the sales staff, by cellular phone, radio frequency, walkie-talkie or other communication as known in the art, or by a public display at a drive through menu or on the outside of the building, customer cell phones or on signage at the facility to directly communicate with the customer.

This methodology can also utilize this type of predictive model not only to react to a lack of demand, but also to try to increase demand for supply that has not yet been provided for. In other words, as discussed above, there are slow periods between rush hours in which production capacity is under utilized. The determination in step 508 can use a predictive model to determine what number of customers can be driven to a facility at known prices or other incentives, and send a notice to the sales staff through a communication device. It will then be determined what capacity would need to be utilized to meet the newly generated demand. In this way a demand can be generated to meet full capacity. In a step 512, management is alerted that the notification has gone out so that it may plan accordingly to utilize the necessary fryers 400 if they are currently idled.

As can be seen the data processing methodology automatically generates a signal that work in process (or vanishing inventory such as airline seats) is not anticipated to be sold and therefore determines that fresh demand is necessary to fill unit production capacity or the flight. The notice in step 510, if associated with an incentive for the customer, may have an expiration time (once demand is greater than that needed in a time interval to prevent waste) to incentivize the customer to purchase wasting assets as quickly as possible. This better normalizes the inventory or production needs.

For ease of explanation, a restaurant 200 was illustrated as having a single server 112, a representative fryer 400 and a single point-of-sale system 300. However, server 112 can be remotely monitoring the point-of-sale network 300 or fryer 400 as well as perform the in-facility notification. The communication system's functionality may be bifurcated and remote from restaurant 200. It is well understood within the art that fryer 400 is representative of ovens, freezers, refrigerators, chillers and holding stations or other vanishing inventory all of which can be monitored to better define the predictive algorithm utilized in step 508.

A restaurant was used by way of example. However, this system and methodology is applicable to any establishment selling a perishable good, such as wine, tobacco, food stuffs or any system in which there is a time limit on the use of the end product, such as beach umbrellas at the end of the day at a resort, souvenirs at a sporting event or the like. Again, as discussed above, the application may be utilized in a vanishing inventory scenario in which at a predetermined time the entire inventory vanishes, such as seats on a departing airplane, empty hotel rooms at the end of a day, or the like. In the vanishing inventory scenario, the embodiment of the invention would include a message for a kiosk at a public area within sufficient distance to the point of sale (in some cases the kiosk itself) or delivery point of the goods so that when the predetermined time period begins, a message is sent to the kiosk or other public messaging system that inventory is available during a predetermined time period at a price designed to increase demand. In such a scenario, the messages may in fact be from competing suppliers, such as airlines, resulting in an efficiency of pricing for substitute goods between competitors. Furthermore, kiosks were used by way of example, but a mobile communication device such as a cell phone, pager, personal geographic location and messaging may be utilized.

A perishable or vanishing inventory (the two may be used interchangeably for the description herein) means a physical product, service or offering of an item, right or privilege that has a time value associated with it. For example, it could be an expiring shelf life of a food item or it could be a seat on a departing airplane. This concept applies to any sale that diminishes in value as availability over time progresses. The airline seat might be worth more the day before a flight but within hours of the flight it is worth zero. Airline reservation systems do not operate within X hours of flight time, usually one day. So this system would have incremental “sales” value to communicate with potential customers within a terminal or near by a terminal say in a nearby hotel at a major airport.

Thus, while there have been shown, described and pointed out novel features of the present invention as applied to preferred embodiments thereof. It will be understood that various omissions, substitutions, and changes in the form and detail are contemplated and may be made by those skilled in the art without departing from the spirit and scope of the invention. It is the intention therefore, to be limited only as indicated by the scope of the claims appended hereto. It is also to be understood that the following claims are intended to cover all of the generic and specific features of the invention herein described and all statements of the scope of the invention, which, as a matter of the language, might be said to fall there between.

What is claimed as new and desired to be protected by Letters Patent of the United States is:

1. A method for increasing demand for a perishable item which is at least one of produced, inventoried and sold at a facility comprising:
monitoring at least one of a sale, production and inventory of the perishable item at a point-of-sale of the perishable item;
determining a time period needed to prevent wastage of the perishable item before the perishable item is no longer capable of sale;
determining a demand time period necessary for existing customers demand to prevent wastage;
notifying sales staff within the proximity of the facility to increase demand when the time period in which the perishable item will waste is less than that of the determined demand time period.

2. The method of claim 1, wherein the time period needed to prevent wastage is determined as a function of current sales of the perishable item, historic sales of the perishable item, and at least one of the historic productions of a preparation device for processing the perishable item, and availability of the preparation device.

3. The method claim 2, further comprising the step of determining to increase demand for the perishable item when the time period in which the perishable item will waste is less than that of the determined demand time period, and the decision to increase demand is made as a function of an available inventory of the perishable item or an available capacity to produce additional quantities of the perishable item at the facility.

4. The method of claim 1, where the time period needed to prevent wastage is determined as a function of available raw material, labor availability, monitored work in process, and available perishable item inventory.

5. The method of claim 3, wherein the determined demand time period is performed at predetermined intervals.

6. The method of claim 1, wherein the perishable item is one of food, a vanishing item, and other perishable product or service.

7. The method of claim 1, wherein one of a sales staff associated with the perishable item or potential customer is notified regarding demand by a display at a point-of-sale device.

8. The method of claim 7, wherein the sales staff or customer is notified by an in-facility electronic communication network.

9. A method for increasing demand for a perishable item which is at least one of produced, inventoried and sold at a facility comprising:
monitoring at least one of a sale, a production and an inventory of the perishable item at a point-of-sale of the perishable item;
determining whether more demand is needed for the perishable item to prevent waste of the perishable item;
determining a time period necessary for existing customers to meet the determined demand;
notifying potential customers within the proximity of the facility when a time period in which the perishable or vanishing item waste is less than that of the determined time period.

10. The method of claim 9, wherein the determination whether more demand is needed as a function of current sales of the perishable item, historic sales of the perishable item and at least one of the historic production of the perishable item by a preparation device for processing the perishable item and/or availability of the preparation device.

11. The method of claim 9, further comprising the step of determining whether to increase demand, and the decision to increase demand is determined as a function of available inventory of the perishable item or capacity to produce additional quantities of a perishable item at the facility.

12. The method of claim 11, where whether more demand is needed determining as a function of available raw material, labor availability, work in process, and perishable item inventory.

13. A system for increasing demand for a perishable item which is at least one of produced, inventoried and sold at a facility comprising;
a preparation device located at the facility;
a point of sale device located at the point of sale of the perishable item.
a predictive server monitoring the operation of the preparation device and the point of sale device and determining an amount of perishable items produced and sold as a function thereof, the server determining the amount of time needed to prevent wastage of the perishable item before the perishable item is no longer capable of sale;
determining a second time period corresponding to the time necessary for existing customers to prevent wastage of the perishable item;
a notification device, in communication with the server, the server outputting an alert notification signal to the notification device when the time period in which the perishable item will waste is greater than that of the second time period.

14. The system of claim 13, wherein the server monitors the amount of perishable items sold and the amount of perishable items produced to determine a perishable item inventory and utilizing the inventory makes a determination that more demand is needed in order to prevent wastage of the perishable item.

15. The method of claim 13, further comprising a database, the database storing a historic production of the preparation device for processing the perishable item and historic sales of the perishable item and the server determining as a function of at least one of a current sales of the perishable item as determined from the point of sale apparatus, historic sales of a perishable item and the historic production of the preparation device and the availability of the preparation device.

16. The system of claim 13, wherein the perishable item is a vanishing asset.

17. The system of claim 13, wherein said notification device notifies a staff at the facility.

18. The system of claim 13, wherein said notification device notifies the general public of the availability and location of the perishable item.

19. A system for increasing demand for a perishable item which is at least one of produced, inventoried and sold at a facility comprising;
a preparation device located at the facility;
a point of sale device located at the point of sale of the perishable item;
a predictive server monitoring the operation of the preparation device and the point of sale device and determining an amount of perishable items produced and sold as a function thereof, the server determining the amount of time needed to prevent wastage of the perishable item before the perishable item is no longer capable of sale; and
determining a second time period corresponding to the time necessary for sales of the perishable item to existing customers to prevent wastage of the perishable item; and
a notification device, in communication with the server, the server outputting an alert notification signal to the notification device when the time period in which the perishable item wastes is less than that of the second time period.

20. The system of claim 19, wherein the server monitors the amount of perishable items sold and the amount of perishable items produced to determine a perishable item inventory and utilizing the inventory makes a determination that more demand is needed in order to prevent wastage of the perishable item.

21. The method of claim 19, further comprising a database, the database storing a historic production of the preparation device for processing the perishable item and historic sales of the perishable item and the server determining whether to increase demand as a function of at least one of a current sales of the perishable item as determined from the point of sale apparatus, historic sales of a perishable item and the historic production of the preparation device and the availability of the preparation device.

22. A system for increasing demand for a perishable item which is at least one of produced, inventoried and sold at a facility comprising;
a preparation device located at the facility;
a point of sale device located at the point of sale of the perishable item;
a predictive server monitoring the operation of the preparation device and the point of sale device and determining an amount of perishable items capable of being produced by the preparation device and capable of being sold, the predictive server determining the amount of time needed to prevent wastage of the perishable item before the perishable item is no longer capable of sale;
determining a second time period corresponding to the time necessary for existing customers to prevent wastage of the perishable item when operating at the capacity capable of being produced and capable of being sold; the predictive server determining an amount of additional demand necessary to prevent wastage of the perishable item capable of being produced and capable of being sold if the time period in which the perishable item wastes is less than the second time period; and
a notification device, in communication with the server, the server outputting an alert notification signal to the notification device when the time period in which the perishable item wastes is less than that of the second time period, the alert notification signal, indicating a need for increased production by the preparation device located at the facility.

23. The system of claim 22, wherein the server monitors the amount of perishable items sold and the amount of perishable items produced to determine a perishable item inventory and utilizing the inventory makes a determination that one of more production and demand is needed in order to prevent wastage of the perishable item.

24. The method of claim 22, further comprising a database, the database storing a historic production of the preparation device for processing the perishable item and historic sales of the perishable item and the server determining a demand and production necessary to prevent a waste of the perishable item as a function of at least one of a current sales of the perishable item as determined from the point of sale apparatus, historic sales of a perishable item and the historic production of the preparation device and the availability of the preparation device.

25. The system of claim 22, wherein said notification device notifies a staff at the facility.

26. The system of claim 22, wherein said notification device notifies the general public of the availability and location of the perishable item.
